(19) United States
(12) Patent Application Publication
(10) Pub. No.: US 2025/0153610 A1
(43) Pub. Date: May 15, 2025

(54) CONTROLLER FOR ELECTRIC VEHICLE

(71) Applicant: TOYOTA JIDOSHA KABUSHIKI KAISHA, Toyota-shi Aichi-ken (JP)

(72) Inventor: Akemi NAKATAKE, Nisshin-shi Aichi-ken (JP)

(73) Assignee: TOYOTA JIDOSHA KABUSHIKI KAISHA, Toyota-shi Aichi-ken (JP)

(21) Appl. No.: 18/941,568

(22) Filed: Nov. 8, 2024

(30) Foreign Application Priority Data
Nov. 14, 2023 (JP) 2023-193982

(51) Int. Cl. B60L 58/16

(52) U.S. Cl. CPC B60L 58/16

(57) ABSTRACT

A controller for an electric vehicle equipped with a battery, includes: a control unit for executing limit control for limiting a current of the battery, a first determination unit for comparing a predicted value and an actual measured value of an internal resistance of the battery, and determining whether the actual measured value is less than the predicted value, and a second determination unit for determining whether the evaluation value exceeds a predetermined value. Further, when the evaluation value does not exceed the predetermined value, the control unit shifts a control state from a limit state where a current of the battery is limited to a relaxed state where a use limit of the current is relaxed compared to the limit state.

### CROSS-REFERENCE TO RELATED APPLICATION(S)

The present application claims priority to and incorporates by reference the entire contents of Japanese Patent Application No. 2023-193982 filed in Japan on Nov. 14, 2023.

### BACKGROUND

The present disclosure relates to a controller for an electric vehicle.

Japanese Laid-open Patent Publication No. 2018-001768 discloses that, if the running path of the electric vehicle includes a section followed by a downhill, the regenerative energy recovered in the downhill when the electric vehicle reaches the end point of the downhill section is maximized, the control is executed to reduce the remaining amount of the battery from the front of the downhill.

### SUMMARY

There is a need for providing a controller for an electrically powered vehicle that is capable of implementing limitations to suppress battery degradation while avoiding excessive limitations.

According to an embodiment, a controller for an electric vehicle equipped with a battery, includes: a control unit for executing limit control for limiting a current of the battery in accordance with an evaluation value indicating a degree of high-rate deterioration of the battery, a first determination unit for comparing a predicted value and an actual measured value of an internal resistance of the battery in order to determine a deterioration of the battery, and determining whether the actual measured value is less than the predicted value corresponding to an aging assumed in advance, and a second determination unit for determining, when the actual measured value is determined to be less than the predicted value in the internal resistance, whether the evaluation value exceeds a predetermined value. Further, when the second determination unit determines that the evaluation value does not exceed the predetermined value, the control unit shifts a control state from a limit state where a current of the battery is limited to a relaxed state where a use limit of the current is relaxed compared to the limit state.

### BRIEF DESCRIPTION OF THE DRAWINGS

FIG. 1 is a schematic diagram illustrating an electric vehicle in an embodiment;

FIG. 2 is a functional block diagram for explaining an electronic controller;

FIG. 3 is a diagram for explaining the downhill control;

FIG. 4 is a diagram illustrating the transition of SOC in a case without down slope control and the transition of SOC in a case with down slope control;

FIG. 5A is a diagram for explaining damage accumulated in the battery in the case of no downhill control;

FIG. 5B is a diagram for explaining damage accumulated in the battery in the case of a downhill control;

FIG. 6 is a diagram illustrating a presence frequency distribution of a user;

FIG. 7A is a diagram for explaining damage accumulated in the battery when traveling at a high load;

FIG. 7B is a diagram for explaining damage accumulated in the battery when traveling at a normal load; and

FIG. 8 is a flowchart illustrating a limiting relaxation processing flow.

### DETAILED DESCRIPTION

In the configuration described in Japanese Laid-open Patent Publication No. 2018-001768, since State Of Charge (SOC) of the batteries is lowered for each downhill section, the frequency of running in a condition where SOC is lower increases. However, the high-rate degradation of the battery will be promoted by increasing the frequency of use in the low SOC range, there is a possibility that the fuel consumption is deteriorated easily take use restriction of the battery.

Hereinafter, a control apparatus for an electric vehicle according to an embodiment of the present disclosure will be specifically described. Note that the present disclosure is not limited to the embodiments described below.

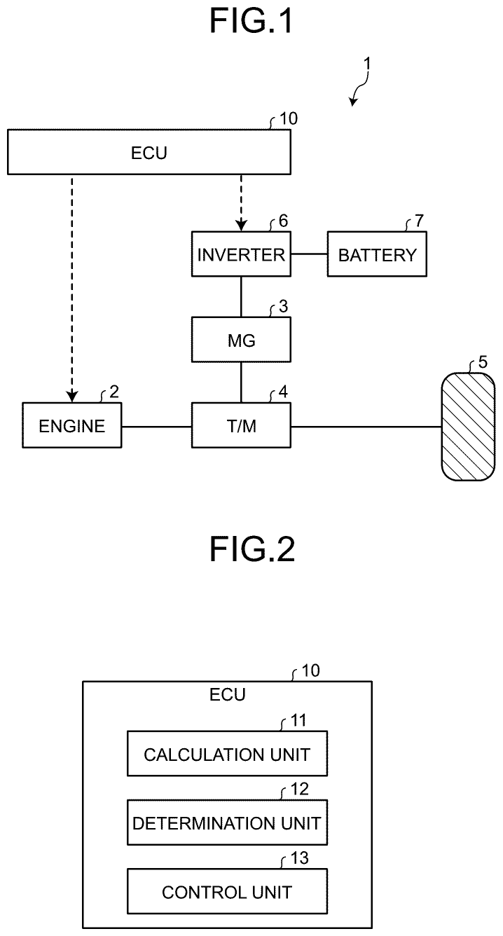

FIG. 1 is a schematic diagram illustrating an electric vehicle according to an embodiment. An electric vehicle 1 includes an engine 2, a motor (MG) 3, a power transmission device (T/M) 4, wheels 5, inverter 6, batteries 7, and a controller (ECU) 10.

The electric vehicle 1 is a hybrid vehicle equipped with the engine 2 and the motor 3. The power output by the engine 2 is transmitted to the wheels 5 through the power transmission device 4. The power transmission device 4 includes a power splitting mechanism. The power division mechanism is composed of a planetary gear mechanism with three rotating elements. The engine 2, the motor 3, and the wheel 5 side are connected to each rotating element of the power division mechanism. This power splitting mechanism distributes the power from the engine 2 to the motor 3 side and the wheel 5 side.

The motor 3 is a motor generator that functions as an electric motor and a generator. The motor 3 is a three-phase AC motor and functions as a power source for traveling. In the electric vehicle 1, the wheels 5 are driven by the power output from the motor 3. The motor 3 and the wheel 5 are connected to be powered through a power transmission device 4. The power output by the motor 3 is transmitted to the wheels 5 through the power transmission device 4. During braking of the electric vehicle 1 or during downhill running, the motor 3 performs regenerative braking and performs regenerative power generation. The electric vehicle 1 recovers the regenerative energy by the motor 3 by performing the regenerative braking. The electric power generated by the motor 3 is stored in the battery 7. The motor 3 is electrically connected to the battery 7 via the inverter 6.

The inverter 6 converts the DC power from the battery 7 into AC power to supply to the motor 3. The inverter 6 drives the motor 3. The inverter 6 is constituted by an electric circuit having a plurality of switching elements so as to be able to energize the three-phase current to the three-phase coil of the motor 3.

The battery 7 is a DC power supply capable of charging and discharging. For example, the battery 7 is constituted by a secondary battery such as nickel hydrogen or lithium ions. The battery 7 discharges power to the inverter 6 side, or charges the power supplied from the inverter 6 side. A step-up converter may be provided between the battery 7 and the inverter 6.

The controller 10 is an electronic control unit (ECU) for controlling the electric vehicle 1. The controller 10 includes a processor and a memory. The processor is composed of a CPU. The memory is composed of RAM and ROM. Signals from the various sensors are input to the controller 10. The controller 10 receives a signal from a vehicle speed sensor for detecting the vehicle speed, a signal from an accelerator opening sensor for detecting the degree of acceleration, a signal from a voltage sensor for detecting the voltage of the battery 7, and a signal from a current sensor for detecting the current input to and output from the battery 7. Herein, with respect to a current value of the current input from the current sensor to the controller 10, if the current is output from the battery 7, the current value is a positive value, and if the current is input to the battery 7, the current value is a negative value. Then, the controller 10 executes various controls based on the signals input from the various sensors. The controller 10 controls the engine 2, the inverter 6 and the battery 7.

The controller 10 functions as an engine controller, a motor controller, and a battery controller.

For example, the controller 10 performs a limiting control that limits the current of the battery 7 to suppress degradation of the battery 7. Further, the controller 10, when the electric vehicle 1 travels on a downhill road, executes a downhill control for recovering the regenerative energy by performing regenerative braking.

As illustrated in FIG. 2, the controller 10 includes a calculation unit 11, a determination unit 12, and a control unit 13.

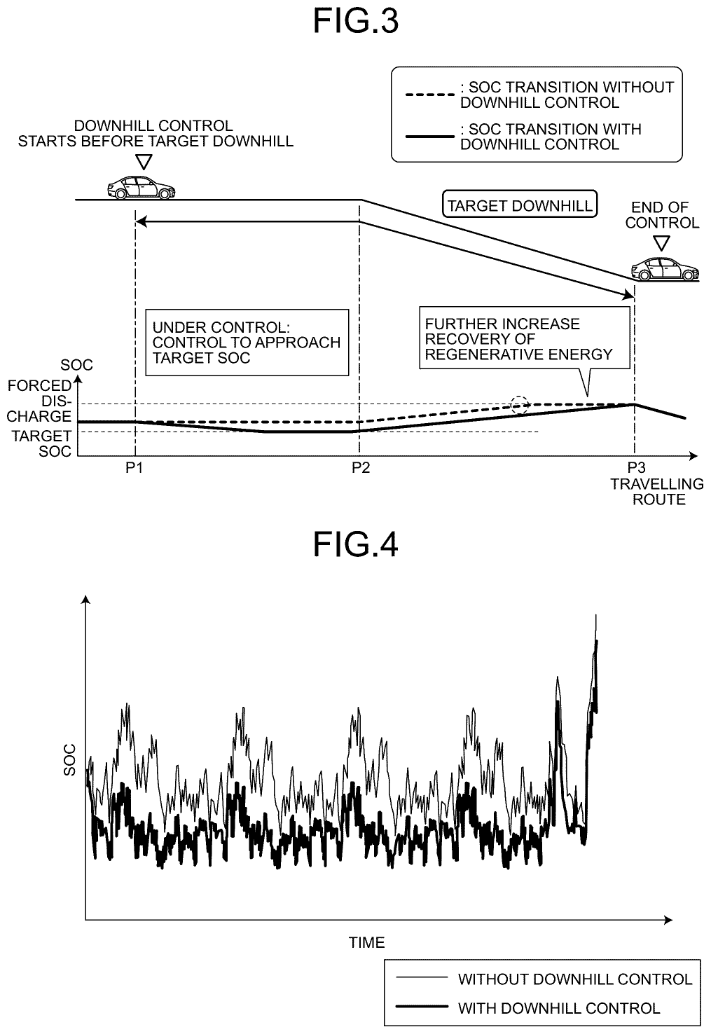

The calculation unit 11 calculates SOC of the battery 7 based on the voltage and current of the battery 7. As illustrated in FIG. 3, when the controller 10 executes the downhill control, the calculation unit 11 calculates a target SOC. The controller 10 executes the downhill control so that SOC follows the target SOC from the front point P1 of the downhill as a target of the downhill control. Various known methods can be used for calculating SOC. For example, controller 10 controls battery 7 so that SOC of battery 7 is between 21% and 86%.

The calculation unit 11 calculates the internal resistance of the battery 7 based on the voltage and current of the battery 7. The calculation unit 11 calculates an actual measured value of the internal resistance of the battery 7 based on a signal input from the voltage sensor and the current sensor. Actual measured value of the internal resistance of the battery 7 is a value indicating the current internal resistance of the battery 7.

The calculation unit 11 calculates the amount of damage D of the battery 7 based on the current input to the battery 7 and the current output from the battery 7 and their energization time. The damage amount D represents the damage caused by the deviation of the salt concentration in the battery 7. The damage amount D is calculated in a predetermined cycle. As the method of calculating the amount of damage D, various known techniques can be used.

The calculation unit 11 calculates an evaluation value ED indicating the degree of high rate deterioration of the battery 7 due to the continuous deviation of the salt concentration of the battery 7 with the charge and discharge of the battery 7. The progress state of the high-rate deterioration is evaluated using the integrated value of the damage amount D. As the calculation method of the evaluation value ED, various known techniques can be used. For example, the evaluation value ED is calculated based on the following equation (1).

$$\sum Dn + 1 = γ \sum Dn + η Dn + 1 \qquad ( 1 )$$

In the above equation (1), ΣDn+1 indicates the current calculated value of the evaluation value. ΣDn indicates the previous operation value of the evaluation value calculated in the previous cycle. γ is the damping coefficient. η is the correction factor. Attenuation coefficient γ is set to a value smaller than 1. The correction coefficient η is calculated based on the following equation (2).

$$η = η1 RI 2 + η2 f ( SOC ) \times I \qquad ( 2 )$$

In the above equation (2), η1 is a proportional constant, a coefficient depending on the current and temperature of the battery 7. η2 is the proportionality factor and is a factor that depends on SOC and current of the cell 7. RI2 is the expansion term of the electrolyte of the cell 7. f(SOC)×I is the expansion and contraction term of the negative electrode of the cell 7.

The evaluation value ΣD, when the battery 7 is the way of use of the overcharge, increases in the negative direction (negative value) by the deviation of the salt concentration in accordance with the overcharge increases. If the battery 7 is the way to use the discharge excess, the evaluation value ΣD is increased in the positive direction (positive value) by the deviation of the salt concentration corresponding to the discharge excess increases.

The high-rate degradation has the property that it is promoted when the current of the charge-direction flows in the low SOC area. As illustrated in FIGS. 3 and 4, when the transition of SOC in the case with downhill control is compared with the transition of SOC in the case without downhill control, it can be seen that the lower SOC area is shifted in the case with downhill control. The controller 10 executes the downhill control when the electric vehicle 1 travels downhill. In the downhill control, as illustrated in FIG. 3, SOC is lowered from the front of the downhill as SOC of the batteries 7 is maximized when the electric vehicle 1 descends downhill. The SOC is lowered to the target SOC while the electric vehicle 1 is traveling in front of a downhill slope. As illustrated in FIG. 4, the SOC is lower with downhill control. In the area where the SOC is low, the expansion and contraction of the negative electrode of the battery 7 become large, and the electrolyte in the battery cell tends to be pushed out, so that the salt density difference in the surface of the battery cell is likely to occur. The High-rate degradation is accelerated when the cell 7 is used in the low SOC range.

The determination unit 12 determines whether to limit the use of the battery 7 in accordance with the evaluation value CD. The determination unit 12 determines whether the evaluation value ΣD has reached a predetermined value is a negative value.

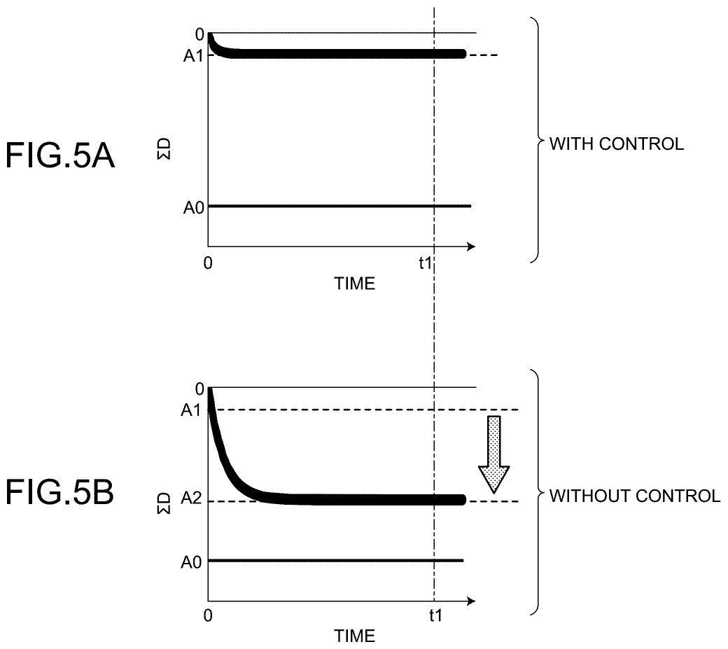

As illustrated in FIG. 5A, the evaluated value ΣD corresponding to the damage accumulated in the battery 7 when there is no downhill control remains in the predetermined value A1 with the transition of the area that does not exceed the threshold A0. As illustrated in FIG. 5B, the evaluation value ΣD corresponding to the damage accumulated in the battery 7 when there is a downhill control, although transitions in an area that does not exceed the threshold A0, a predetermined value A2 in which the amount of damage is greater than the predetermined value A1. The absolute value of the absolute value and the predetermined value A2 of the predetermined value A1 is smaller than the absolute value of the threshold A0. The absolute value of the predetermined value A1 is smaller than the absolute value of the predetermined value A2.

The control unit 13 executes a limit control for limiting the current of the battery 7 in accordance with the evaluation value ΣD. The control unit 13 limits the use of batteries 7 so that the evaluated value ΣD does not exceed the threshold A0. The use limit of the battery 7, although it is possible to take out the power from the battery 7, the usable current is restricted control state.

The evaluated value ΣD is the absolute value increases due to the deviation of salinity due to the increase in the frequency of use in the low SOC range. The use condition of the cell 7 is limited so that the evaluated value ΣD does not exceed the threshold A0. The threshold A0 is set on the assumption of an evaluation value ΣD which is accumulated by the electric vehicle 1 traveling at a high load. The accumulated amount of the evaluation value ΣD of the battery 7 varies depending on how the driver operates the electric vehicle 1. Compared with the case where the electric vehicle 1 runs under a normal load and the case where the electric vehicle 1 runs under a high load, the evaluation value ΣD is more accumulated in the case of the high load.

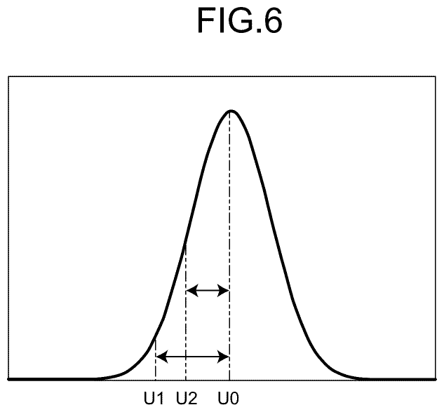

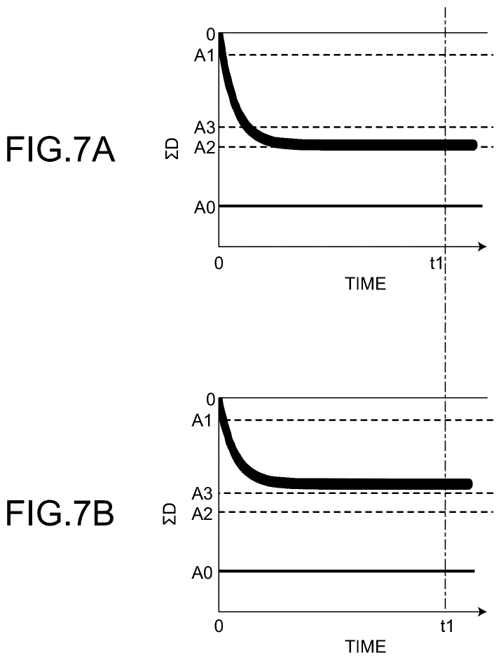

As illustrated in FIG. 6, according to the presence frequency distribution of the user, there are more U2 of users who perform normal load running than U1 of users who perform high load running. There are more common user U2 for the median U0 of the user's presence frequency distribution than the user U1 for high-load driving. The thresholding A0 is set to protect the user U1 for high-load driving. In other words, thresholds set to protect typical user U2 may exist separately from threshold A0. Therefore, the controller 10, as illustrated in FIGS. 7A and 7B, calculates a threshold A3 corresponding to the common user U2, comparing the threshold A3 and the evaluated value ΣD. The threshold A3 is a threshold value that is set when the running load of the electric vehicle 1 is a normal load. The absolute value of the threshold A3 is greater than the absolute value of the predetermined value A1 and less than the absolute value of the predetermined value A2.

As illustrated in FIG. 7A, when the user U1 of the high-load running drives the electric vehicle 1, the evaluated value ΣD is within an area that does not exceed the threshold A0, but transits in an area that exceeds the threshold A3. As illustrated in FIG. 7B, when a typical user U2 drives the electric vehicle 1, the evaluated value CD is within an area that does not exceed the threshold A0 and transitions through an area that does not exceed the threshold A3. The evaluation value ΣD illustrated in FIGS. 7A and 7B illustrates the case with downhill control. It can be seen that the accumulation of the estimated ΣD varies depending on whether U1 of users is high-load driving or U2 of common users. The threshold A0 is a threshold set on the assumption of the user U1 of high-load running. The controller 10 may be overly limited to typical user U2 by imposing limits on the use of the batteries 7 to ensure that the estimate ΣD does not exceed the threshold A0 by imposing limits on U1 of users traveling at high loads. Therefore, the controller 10 is configured to alleviate the use limitation of the batteries 7 when the driver of the electric vehicle 1 is a common user U2.

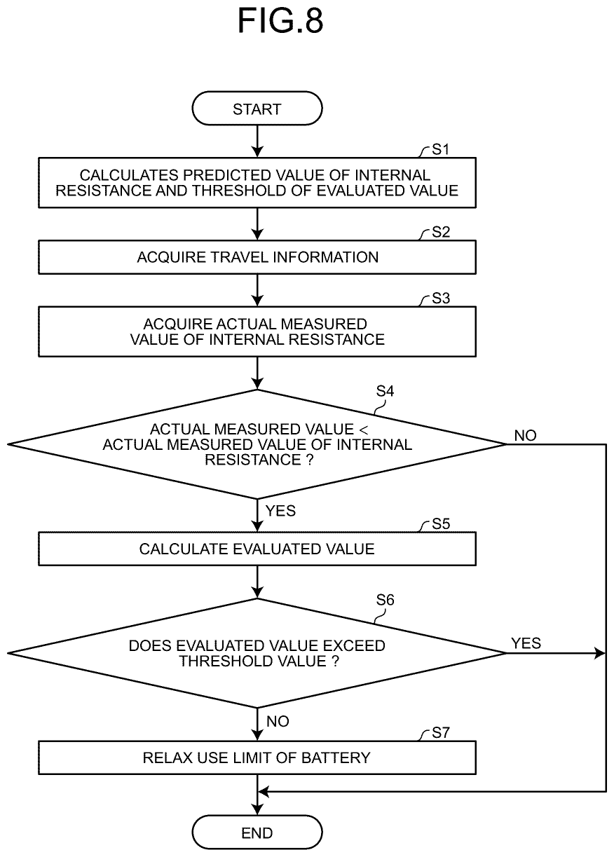

FIG. 8 is a flowchart illustrating a limiting relaxation processing flow. The control illustrated in FIG. 8 is executed by the controller 10.

The controller 10 calculates the predicted value of the internal resistance of the battery 7 and the threshold of the evaluated value ΣD (step S1). In step S1, the predicted value of the internal resistance and the threshold value of the evaluated value ΣD corresponding to the aging of the batteries 7 are calculated by using the map stored in advance in the storage unit. In the storage unit, a map illustrating the internal resistance increased by aging deterioration is stored. Based on the map, the calculation unit 11 can calculate an internal resistance when the life of the battery 7 is equivalent to 5 years and an internal resistance when the life of the battery 7 is equivalent to 10 years. The calculation unit 11 calculates the thresholds of the evaluation-value ΣD on the assumption of aging degradation of the batteries 7 used by a common user U2. For example, when the battery 7 is used for five years, the calculation unit 11 calculates a predicted value of the internal resistance corresponding to five years from the map, and calculates a threshold A3 of the evaluation value ΣD on the assumption that a typical user U2 uses the battery 7 for five years.

The controller 10 acquires the travel information of the electric vehicle 1 (step S2). In step S2, the traveling information indicating the traveling history of the electric vehicle 1 accumulated in the storage unit of the electric vehicle 1 are acquired. The controller 10 acquires the actual data of the travel history.

The controller 10 acquires the measured value of the internal resistance of the battery 7 (step S3). In step S3, an actual measurement of the internal resistance of the cell 7 is calculated. The calculation unit 11 calculates an actual measured value indicating the internal resistance of the current battery 7.

The controller 10 determines whether the measured value is smaller than the predicted value for the internal resistance of the battery 7 (step S4). In step S4, the predicted value of the internal resistance calculated by the step S1 is compared with the measured value of the internal resistance obtained by step S3, whether the measured value is smaller than the predicted value is determined. Since the internal resistance of the battery 7 rises due to aging deterioration, the determination unit 12 by determining whether the measured value of the internal resistance is lower than the predicted value, the aging deterioration of the battery 7 is determined whether it is a state that is not advanced than assumed.

If the measured value for the internal resistance of the cell 7 is determined not to be smaller than the predicted value (No in step S4), the control routine ends. If it is determined negatively in step S4, it is determined that the aging of the batteries 7 is advancing more than expected, this control routine ends.

If the measured value for the internal resistance of the cell 7 is determined to be smaller than the predicted value (Yes in step S4), the controller 10 calculates the evaluated value ΣD (step S5). The calculation unit 11 calculates the current evaluation value ΣD using the above equations (1) and (2).

The controller 10 determines whether the evaluated value ΣD is above the threshold (step S6).

In step S6, the threshold calculated by step S1, and the evaluation value ΣD calculated by the step S5 is compared, whether the evaluation value ΣD exceeds the threshold is determined. In step S1, a threshold value assuming a common user U2, that is, a threshold A3 illustrated in FIGS. 7A and 7B is calculated. Therefore, in step S6, the determination unit 12 determines whether or not the evaluated value ΣD exceeds the threshold A3 set for a typical user U2. When it is determined that the evaluated value ΣD exceeds the threshold A3 in step S6, it is determined that the driver of the electric vehicle 1 is the user U1 of the high-load running, as illustrated in FIG. 7A. In step S6, it is determined whether the driver of the electric vehicle 1 is the user U1 of the high-load running or the common user U2.

If the evaluated value ΣD is determined to exceed the threshold value (Yes in step S6), the control routine ends. When it is determined in step S6 that the evaluated value ΣD exceeds the threshold A3, the driver is determined to be the user U1 of the high-load running.

If the evaluated value ΣD is determined not to exceed the threshold value (No in step S6), the controller 10 relaxes the use limit of the battery 7 (step S7). When it is determined that the evaluated value ΣD does not exceed the threshold A3 in S6 of steps, it is determined that the driver of the electric vehicle 1 is a common user U2, as illustrated in FIG. 7B. The control unit 13 in step S7 shifts the control state from a limit state which limits the current of the battery 7 to a relaxed state which relaxes the use limit of the battery 7 than the limit state. The relaxed state is a state in which a current higher than the limited state is usable. Since the controller 10 can execute the downhill control, the limit control is executed so that the evaluated value ΣD does not exceed the threshold A0 when the user U1 of the high-load running operates. Therefore, prior to step S7 being processed, the use of the cell 7 is limited so that the threshold A0 is not exceeded for the estimate ΣD for typical user U2 operation. In other words, the limit control takes place quickly, which means that the performance of the battery 7 is not exhausted. Since the limit control takes place quickly in this way, the process of step S7 cancels or relaxes the limit. This will consume the performance of the battery 7. Performing the process of step S7, this control routine ends.

As described above, according to the embodiment, since the ratio of users who are traveling easily high-rate deteriorated is small, the limitation of the current of the battery 7 is relaxed by shifting the control state from the limiting state in which the user U1 of the high-load traveling is assumed to the relaxed state in which the common user U2 is assumed. Since the current larger than the limit state can be used in the relaxed state, the output of the engine 2 to the required power of the electric vehicle 1 can be reduced, thereby improving the fuel consumption.

In the present disclosure, excessive restrictions can be avoided while implementing restrictions for suppressing deterioration of the battery.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A controller for an electric vehicle equipped with a battery,
the controller includes:
a control unit for executing limit control for limiting a current of the battery in accordance with an evaluation value indicating a degree of high-rate deterioration of the battery,
a first determination unit for comparing a predicted value and an actual measured value of an internal resistance of the battery in order to determine a deterioration of the battery, and determining whether the actual measured value is less than the predicted value corresponding to an aging assumed in advance, and a second determination unit for determining,
when the actual measured value is determined to be less than the predicted value in the internal resistance, whether the evaluation value exceeds a predetermined value, wherein
when the second determination unit determines that the evaluation value does not exceed the predetermined value, the control unit shifts a control state from a limit state where a current of the battery is limited to a relaxed state where a use limit of the current is relaxed compared to the limit state.

2. The controller for an electric vehicle according to claim 1, wherein the relaxed state is a state where higher current can be used compared to the limited state.

3. The controller for an electric vehicle according to claim 2, wherein the predetermined value is a threshold value that is set when the running load of the electric vehicle is a normal load.
